(19) United States
(12) Patent Application Publication
(10) Pub. No.: US 2012/0301624 A1
(43) Pub. Date: Nov. 29, 2012

(54) Spray nozzle and method for atmospheric spraying, device for coating, and coated component

(76) Inventors: Andy Borchardt, Berlin (DE); Mario Felkel, Berlin (DE); Sascha Martin Kyeck, Berlin (DE); Martin Stambke, Kleinpaschleben (DE)

(21) Appl. No.: 13/574,819

(22) PCT Filed: Jul. 13, 2010
(86) PCT No.: PCT/EP2010/060051

§ 371 Date: Jul. 24, 2012

(30) Foreign Application Priority Data
Jan. 28, 2010 (EP) 10000895.2

(51) Int. Cl. C23C 4/12; B05B 1/28

(52) U.S. Cl. 427/446; 239/290; 118/323

(57) ABSTRACT

A spray nozzle for atmospheric plasma spraying is provided. The nozzle includes an attachment at an axial end of the spray nozzle from which a protective gas may be discharged in the outflow direction. By means of a plasma spray nozzle that enables atmospheric plasma spraying using protective gas, it is also possible to deposit oxidation-sensitive metal coatings in atmosphere.

### CROSS REFERENCE TO RELATED APPLICATIONS

This application is the US National Stage of International Application No. PCT/EP2010/060051, filed Jul. 13, 2010 and claims the benefit thereof. The International Application claims the benefits of European Patent Office application No. 10000895.2 EP filed Jan. 28, 2010. All of the applications are incorporated by reference herein in their entirety.

### FIELD OF INVENTION

The invention relates to a process for atmospheric plasma spraying, to an apparatus for coating and to a component.

### BACKGROUND OF INVENTION

Atmospheric plasma spraying is a cost-effective alternative of plasma spraying since in this case it is possible to dispense with a vacuum installation. This is not possible with every powder, however. In the case of other coating processes, specific properties of the metallic layer are often not achieved.

In order to increase the efficiency of a turbine, the turbine inlet temperature of the gas has to be increased. So that the turbine blades or vanes do not suffer any damage at these high temperatures of >800° C., a metallic coating as protection against oxidation and an adhesion promoting layer are applied, and a ceramic coating for thermal insulation is applied thereto. So that the ceramic coating bonds to the adhesion promoting layer, a very rough surface is required. At present, this adhesion promoting layer is usually applied by vacuum processes for spraying technology, which are very complex and expensive. Furthermore, they lack the flexibility to also use coating materials other than MCrAlY for adhesion promoting layers. For these reasons, a start has therefore been made presently to replace the vacuum processes with other processes. One of these processes is high velocity flame spraying (HVOF). For technological reasons, it is very difficult to produce the required rough coating by way of an HVOF process. Particularly in the case of flat coating angles, i.e. <90° to the surface, a sufficiently rough surface cannot be produced. Coating by means of atmospheric plasma spraying is not possible since the MCrAlY alloy oxidizes under the action of the atmospheric oxygen.

### SUMMARY OF INVENTION

It is therefore an object of the invention to solve the abovementioned problem.

The object is achieved by a plasma spray nozzle as claimed in the claims, by a process as claimed in the claims, by an apparatus as claimed in the claims and by a component as claimed in the claims.

### BRIEF DESCRIPTION OF THE DRAWINGS

The dependent claims list further advantageous measures which can be combined with one another, as desired, in order to obtain further advantages.

FIG. 1 shows an attachment for a plasma spray nozzle,

FIGS. 2 and 3 show different attachments for the plasma spray nozzle,

FIG. 4 shows a perspective view of a gas turbine,

FIG. 5 shows a perspective view of a turbine blade or vane,

FIG. 6 shows a perspective view of a combustion chamber, and

FIG. 7 shows a list of superalloys.

The description and the figures represent merely exemplary embodiments of the invention.

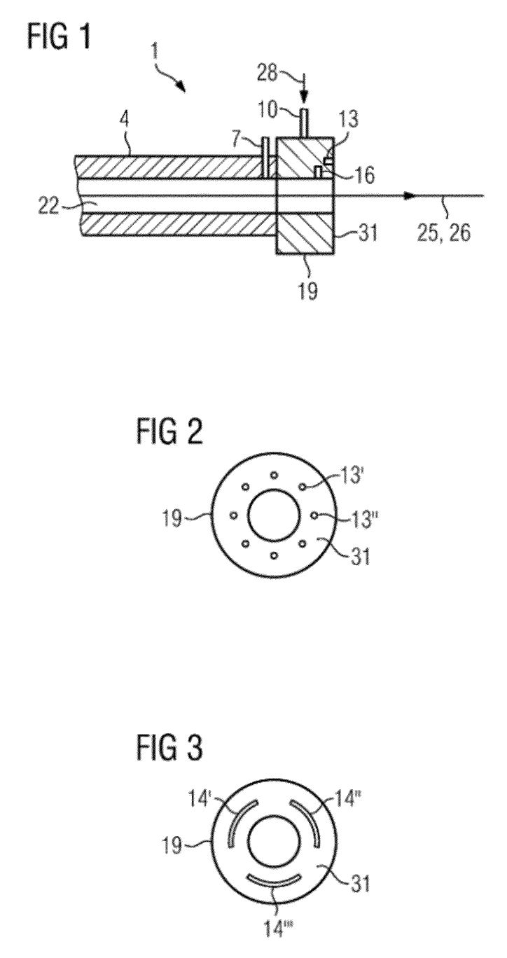

FIG. 1 shows a spray nozzle 1.

### DETAILED DESCRIPTION OF INVENTION

The spray nozzle 1 has a conventional nozzle 4 known from the prior art relating to plasma spray nozzles (APS, . . . ) and an attachment 19. Parallel to a longitudinal direction 26 of an inner channel 22 of the nozzle 4, at least partially molten coating material heated by a plasma flows from the nozzle 4 in an outflow direction 25. The plasma is produced in the inner channel 22 of the nozzle 4.

The nozzle 4 is only modified to the effect that an attachment 19 can be fastened to it. The attachment 19 extends the inner channel of the nozzle 4. A protective gas 28 flows out through holes 13, 13′, 13″ on the end face 31 of the attachment 19, . . . , which preferably have a nozzle-like form, (also see FIGS. 2 and 3) and produces a desired geometry of a protective gas shroud around the outflowing coating material. The protective gas 28 can also flow out of slots 14′, 14″ arranged in a circle (FIG. 3). It is preferable for at least two, in particular four, slots 14′, 14″, . . . to be present.

The protective gas 28 can preferably be argon, helium, nitrogen or a mixture thereof.

The holes 13, 13′, 13″, . . . and/or slots 14′, 14″, . . . are oriented in the longitudinal direction 26 in such a way that the protective gas 28 flows out in an outflow direction 25, the outflow direction 25 running parallel to the longitudinal direction 26.

The end face 31 of the attachment 19 on the nozzle 4 is preferably provided with holes 13′, 13″ arranged in a circle (FIG. 2).

The holes 13′, 13″, . . . and/or the slots 14′, 14″, . . . are preferably distributed uniformly in the radial circumferential direction over the end face 31.

It is preferable for some of the protective gas 28 to also flow through at least one opening 16 into the part of the inner channel 22 of the attachment 19. This serves for cooling the attachment 19.

A powder feed 7 is also present and is preferably arranged upstream of the attachment 19.

The powder feed 7 can also be present at any other location on the nozzle 4.

The attachment 19 preferably has an outer fixed shell, such that only a few discrete holes 13, 13′, . . . or slots 14′, 14″, . . . are present.

Similarly, the extension of the channel 22 in the region of the attachment is formed by a fixed inner shell of the attachment.

The attachment 19 is preferably not made of a porous solid material.

In an appropriate coating apparatus, cost-effective coating can be carried out by means of the HVOF process. However, in order to effect coating in the case of specific roughnesses or at an angle of up to 45° to the coating surface, an APS (atmospheric plasma spraying) nozzle which has an appropriate attachment 19 as per FIG. 1 has to be used. Both coating options HVOF, APS are now preferably implemented in one apparatus.

A rougher coating is applied using an APS burner to an existing coating, which has been applied by means of an HVOF process. After the HVOF coating, the HVOF nozzle is removed and an APS nozzle 1 is installed in the same apparatus.

In this case, an attachment 19 is mounted on an APS burner (nozzle 4). A protective gas 28, e.g. nitrogen, is conducted through said attachment 19. Said protective gas at the same time also cools the attachment 19. The, preferably metallic, coating material heated by the plasma flows through the inside of the attachment 19.

It is also possible for the entire layer to be produced with the attachment 19.

The coating material is at least partially melted in the plasma jet and is applied to a substrate. The protective gas 28 is conducted through the attachment 19 in such a manner that, after the molten particles leave the spray nozzle 1, a protective gas shroud forms around the particle jet.

This is particularly important in the case of metallic coating material, which would oxidize excessively during plasma spraying but, by contrast, would not oxidize to such an extent during HVOF.

This shroud prevents oxidation of the particles. Since the particle velocity during APS is significantly lower than during HVOF, the particles remain adhering to the substrate surface more effectively. This makes it possible to effect coating at an angle of up to 45° to the surface. The greater roughness, as compared with HVOF, is always present in this process.

The configuration of the attachment 19 makes it possible to influence the protective gas shroud. Various geometries and arrangements of the discharge holes 13, 13′, 13″ or slots 14′, 14″, 14, . . . in turn influence the formation and the geometry of the protective gas shroud.

For the widest variety of applications, it is merely necessary to exchange the attachment 19. It is therefore possible to test and assess the widest variety of attachment configurations 19 and therefore protective gas shroud configurations with a nozzle 4. If the protective gas shroud has to be more or less twisted for application reasons, only the geometry of the protective gas discharge holes is adapted.

In the case of turbine blades or vanes 120, 130 with a complicated geometry and with poor accessibility to the regions to be coated, this type of coating is a good and simple solution. Expensive low-pressure and vacuum installations become superfluous, since the same installations as for the thermal barrier coating can be used. Compared to layers sprayed by HVOF, the layers which thus arise have a significantly higher roughness and a better layer morphology at sites which are difficult to reach. Owing to the variability of the easy-to-exchange attachment 19, every application can be covered. The base body 4 remains on the plasma burner, as a result of which complex assembly and disassembly are no longer required.

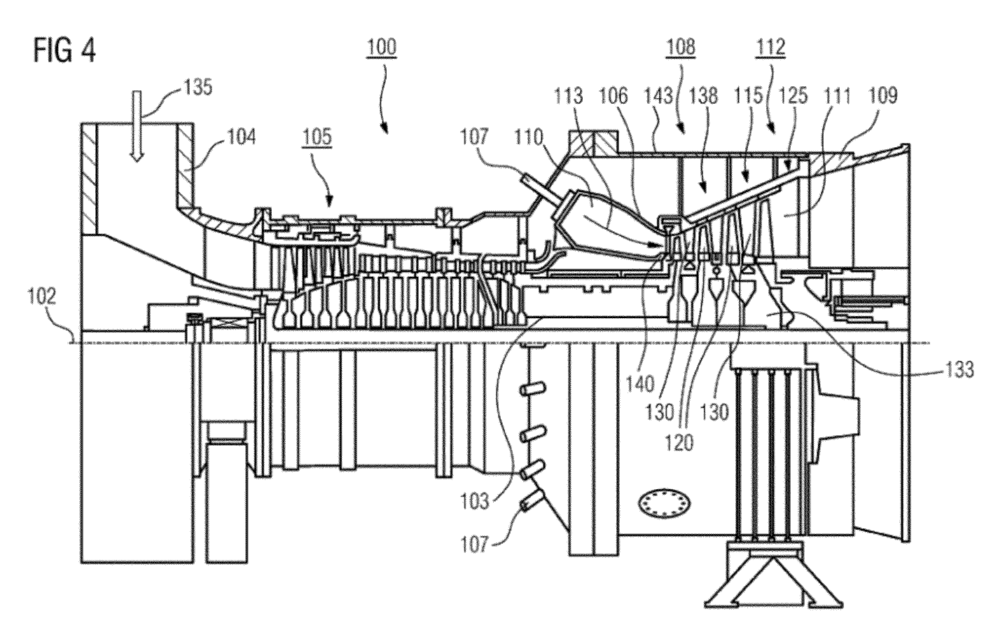

FIG. 4 shows, by way of example, a partial longitudinal section through a gas turbine 100.

In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B 1, EP 1 306 454, EP 1 319 729 A1, WO 99/67435 or WO 00/44949.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

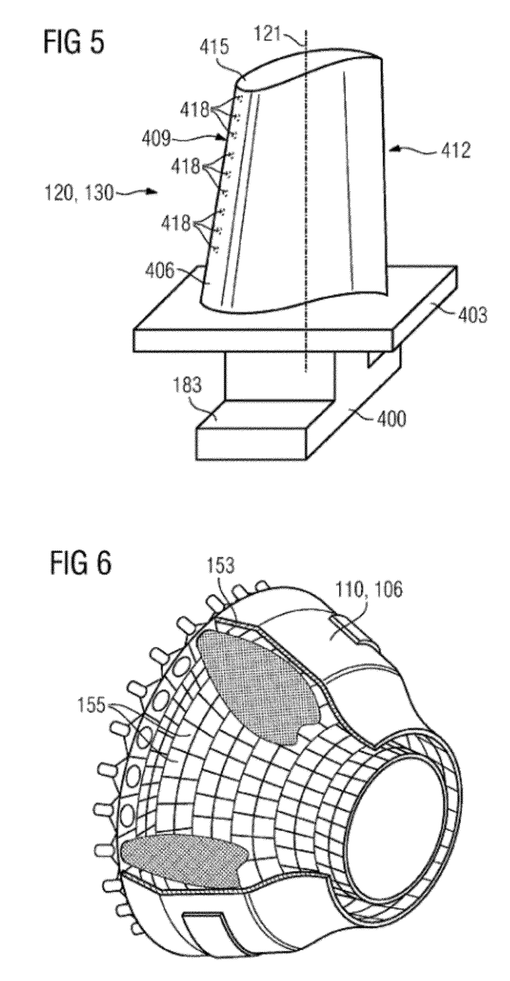

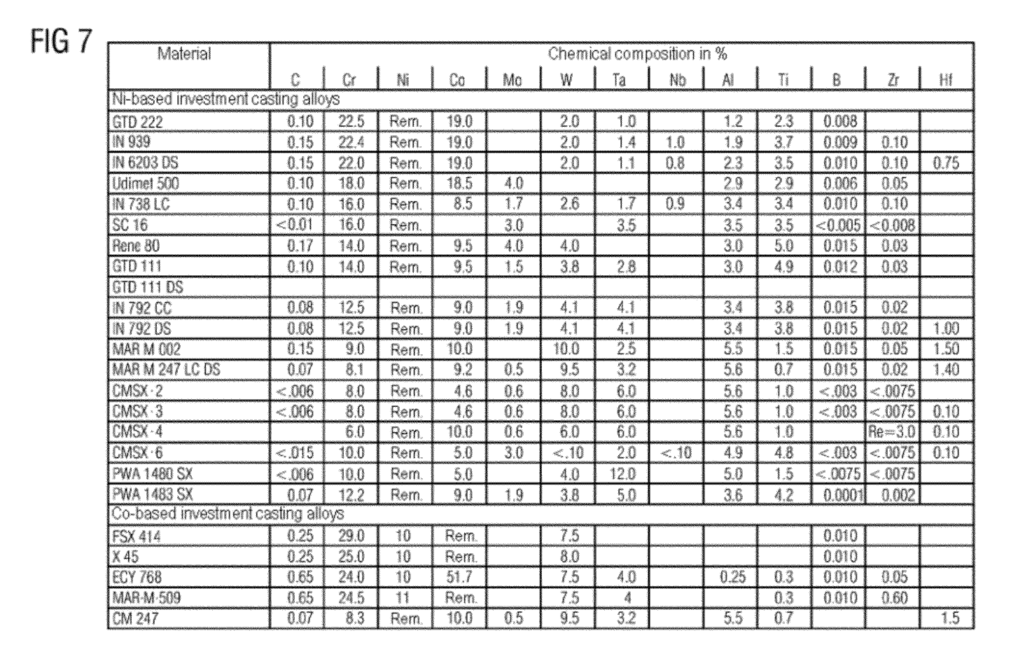

FIG. 5 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B 1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B 1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (HO). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer, to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

The thermal barrier coating covers the entire MCrAlX layer. Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

FIG. 6 shows a combustion chamber 110 of the gas turbine 100.

The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example ceramic, thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from turbine blades or vanes 120, 130 or heat shield elements 155 (e.g. by sand-blasting). Then, the corrosion and/or oxidation layers and products are removed. If appropriate, cracks in the turbine blade or vane 120, 130 or the heat shield element 155 are also repaired. This is followed by recoating of the turbine blades or vanes 120, 130 or heat shield elements 155, after which the turbine blades or vanes 120, 130 or the heat shield elements 155 can be reused.

1-14. (canceled)

15. A spray nozzle for atmospheric plasma spraying from which a coating material is discharged in an outflow direction, comprising:
a nozzle including an attachment at an axial end from which a protective gas may be discharged in the outflow direction,
wherein the end face of the attachment is provided with a plurality of discharge holes for the protective gas,
wherein the spray nozzle has a fixed outer and/or inner shell, and
wherein the attachment does not consist of a porous material.

16. The spray nozzle as claimed in claim 15, wherein the shape of the attachment is variable.

17. The spray nozzle as claimed in claim 15, wherein a powder feed is disposed on the nozzle or on the attachment.

18. The spray nozzle as claimed in claim 17, wherein the powder feed is disposed upstream of the attachment on the nozzle.

19. The spray nozzle as claimed in claim 15, wherein a portion of the protective gas flows through an inner opening into an inner channel of the attachment.

20. The spray nozzle as claimed in claim 15,
wherein the plurality of discharge holes for the protective gas include a nozzle-like form.

21. The spray nozzle as claimed in claim 15, wherein the plurality of discharge holes are distributed uniformly in the radial circumferential direction over the end face.

22. A process for coating a component, comprising:
first coating a component using HVOF (high velocity flame) thermal spraying; and
then coating the component using atmospheric plasma spraying by means of a spray nozzle for atmospheric plasma spraying from which coating material is discharged in an outflow direction,
wherein a nozzle includes an attachment at an axial end from which a protective gas is discharged in the outflow direction, and
wherein the process is effected using the same coating apparatus.

23. The process as claimed in claim 22, wherein a metallic powder is sprayed.

24. An apparatus for coating a component, comprising:
a mount for the component;
a component; and
a robot which moves a spray nozzle as claimed in claim 15.

25. The apparatus as claimed in claim 24,
wherein the apparatus can receive a spray nozzle as claimed in claim 15.

26. A spray nozzle for atmospheric plasma spraying from which a coating material is discharged in an outflow direction, comprising:
a nozzle including an attachment at an axial end from which a protective gas is discharged in the outflow direction,
wherein the end face of the attachment is provided with a plurality of slots for the protective gas, and
wherein the spray nozzle has a fixed outer and/or inner shell, and
wherein the attachment does not consist of a porous material.

27. The spray nozzle as claimed in claim 26, wherein the shape of the attachment is variable.

28. The spray nozzle as claimed in claim 26, wherein a powder feed is disposed on the nozzle or on the attachment.

29. The spray nozzle as claimed in claim 28, wherein the powder feed is disposed upstream of the attachment on the nozzle.

30. The spray nozzle as claimed in claim 26, wherein a portion of the protective gas flows through an inner opening into an inner channel of the attachment.

31. The spray nozzle as claimed in claim 26,
wherein the plurality of slots for the protective gas include a nozzle-like form.

32. The spray nozzle as claimed in claim 26,
wherein the plurality of slots are distributed uniformly in the radial circumferential direction over the end face.
